(19) United States
(12) Patent Application Publication
(10) Pub. No.: US 2026/0058064 A1
(43) Pub. Date: Feb. 26, 2026

(54) COMPOSITE PARTICLE AND MULTILAYER CERAMIC CAPACITOR INCLUDING THE SAME

(71) Applicants: SAMSUNG ELECTRO-MECHANICS CO., LTD., Suwon-si (KR); KOREA UNIVERSITY RESEARCH AND BUSINESS FOUNDATION, Seoul (KR)

(72) Inventors: Da Mi Kim, Suwon-si (KR); Yun Chan Kang, Seoul (KR); Sujin Lee, Suwon-si (KR); Daewoo Yoon, Suwon-si (KR); Bumsuk Kang, Suwon-si (KR); Junghyun Kim, Suwon-si (KR)

(73) Assignees: SAMSUNG ELECTRO-MECHANICS CO., LTD., Suwon-si (KR); KOREA UNIVERSITY RESEARCH AND BUSINESS FOUNDATION, Seoul (KR)

(21) Appl. No.: 19/058,811

(22) Filed: Feb. 20, 2025

(30) Foreign Application Priority Data
Aug. 23, 2024 (KR) 10-2024-0113669
Nov. 8, 2024 (KR) 10-2024-0158452

(51) Int. Cl. H01G 4/232; H01G 4/008; H01G 4/12; H01G 4/248; H01G 4/30

(52) U.S. Cl. CPC H01G 4/2325; H01G 4/008; H01G 4/12; H01G 4/248; H01G 4/30

(57) ABSTRACT

A composite particle according to an embodiment of the present disclosure includes a conductive core, a conductive oxide layer disposed on the conductive core and including a metal oxide, and a coating disposed on the conductive oxide layer and including glass.

### CROSS-REFERENCE TO RELATED APPLICATION

This application claims priority to and the benefit of Korean Patent Application No. 10-2024-0113669 filed in the Korean Intellectual Property Office on Aug. 23, 2024, and Korean Patent Application No. 10-2024-0158452 filed in the Korean Intellectual Property Office on Nov. 8, 2024, the entire contents of which are incorporated herein by reference.

### BACKGROUND OF THE INVENTION

### (a) Field of the Invention

The present disclosure relates to a composite particle and a multilayer ceramic capacitor including the same.

### (b) Description of the Related Art

Electronic components using ceramic materials include capacitors, inductors, piezoelectric elements, varistors, or thermistors. Among such ceramic electronic components, a multilayer ceramic capacitor (MLCC) may be used in various electronic devices due to its small size, high capacitance, and easy mounting.

For example, the multilayer ceramic capacitor may be used for chip-type capacitors that are mounted in boards of various electronic products to charge or discharge electricity, including imaging devices such as liquid crystal displays (LCDs), plasma display panels (PDPs), and organic light-emitting diode (OLED) displays, computers, personal portable terminals, and smartphones.

Recently, with the miniaturization of electronic products, multilayer ceramic capacitors are also required to be ultra-miniaturized and have ultra-high capacitance. To this end, multilayer ceramic capacitors are being manufactured with a structure in which dielectric layers and internal electrode layers are thinned and a larger number of dielectric layers and internal electrode layers are stacked. These ultra-small and ultra-high-capacitance multilayer ceramic capacitors are recently being used in fields that require a high level of reliability, such as electric vehicles, and therefore, high stability and reliability are required.

### SUMMARY OF THE INVENTION

An aspect of the present disclosure attempts to provide a composite particle with improved structural stability and dispersibility.

An aspect of the present disclosure attempts to provide a multilayer ceramic capacitor with improved stability and capacitance characteristics.

However, the problems to be solved by embodiments of the present disclosure are not limited to the above-described problems, and can be variously expanded within the scope of the technical spirit included in the present invention.

Some embodiments provide a composite particle including a conductive core, a conductive oxide layer disposed on the conductive core and including a metal oxide, and a coating disposed on the conductive oxide layer and including glass.

The conductive core may include copper.

The metal oxide may include a copper oxide.

The glass may include at least one oxide selected from the group consisting of FeO, Fe₂O₃, Fe₃O₄, SnO, SnO₂, CuO, Cu₂O, MnO, Mn₂O, Mn₂O₃, Mn₃O₄, Ag₂O, GeO₂, In₂O₃, CoO, TiO₂, and P₂O₅.

A content of the oxide in a total weight of the coating may be in a range from 0.01 wt % to 20 wt %.

A thickness of the conductive oxide layer may be in a range from 1 nm to 20 nm. A thickness of the coating may be in a range from 1 nm to 50 nm.

An average particle diameter (D50) may be in a range from 0.1 μm to 1 μm.

Some embodiments provide a multilayer ceramic capacitor including a capacitor body including a dielectric layer and an internal electrode layer, and an external electrode disposed on an outer side of the capacitor body and including a composite particle, in which the composite particle includes a conductive core, a coating disposed on the conductive core and including glass, and a conductive oxide layer disposed between the conductive core and the coating and including a metal oxide.

The internal electrode layer may be provided in plurality, the external electrode may include an electrode layer disposed on an end surface of the capacitor body so as to be electrically connected to at least one of the internal electrode layers, and the electrode layer may include the composite particle.

The internal electrode layer may include a first internal electrode and a second internal electrode alternately stacked in a stacking direction, the multilayer ceramic capacitor may have a width direction and a length direction that are perpendicular to the stacking direction and perpendicular to each other, and in a cross-section taken along the length direction and the stacking direction perpendicular to the width direction at a center in the width direction of the multilayer ceramic capacitor, an average area of glasses included in the electrode layer may be in a range from 0.1 μm² to 5 μm².

The average area of the glasses may be measured by scanning electron microscopy (SEM) analysis on the electrode layer in the cross-section.

The electrode layer may further include at least one selected from the group consisting of a conductive particle, a glass frit, and an organic material.

A content of the composite particle in a total weight of the composite particle and the conductive particle may be in a range from 40 wt % to 100 wt %.

Some embodiments provide a method for manufacturing a multilayer ceramic capacitor, including: applying a paste for forming an electrode layer to one surface of a capacitor body including a dielectric layer and an internal electrode layer; and sintering the paste to form the electrode layer of an external electrode, in which the paste includes a composite particle and optionally a conductive metal, and a content of the composite particle is in a range from 40 wt % to 100 wt % of a total weight of the composite particle and the conductive metal.

In the method for manufacturing a multilayer ceramic capacitor, the paste may further include at least one selected from the group consisting of a glass frit and an organic material.

According to an embodiment of the present disclosure, the structural stability of the composite particle can be improved.

According to an embodiment of the present disclosure, a decrease in electrode density due to melting of coarse glass can be suppressed, and a decrease in glass dispersibility due to agglomeration of fine glass frits can be prevented. Therefore, the stability and reliability of the external electrode can be improved, and the capacitance characteristics of the multilayer ceramic capacitor can be enhanced.

### BRIEF DESCRIPTION OF THE DRAWINGS

FIG. 1 is a cross-sectional view conceptually showing a composite particle according to an embodiment.

FIG. 2 is a transmission electron microscopy (TEM) analysis image of a composite particle according to an embodiment.

FIGS. 3(a) and 3(b) are scanning electron microscopy (SEM) analysis images showing electrode densities according to coating thicknesses of composite particles in an electrode using composite particles according to an embodiment.

FIG. 4 is a perspective view showing a multilayer ceramic capacitor according to an embodiment.

FIG. 5 is a cross-sectional view of the multilayer ceramic capacitor taken along line I-I′ of FIG. 4.

FIG. 6 is a cross-sectional view of the multilayer ceramic capacitor taken along line II-II′ of FIG. 4.

FIG. 7 is a SEM analysis image of an external electrode of a multilayer ceramic capacitor according to Example 3.

FIG. 8 is a SEM analysis image of an external electrode of a multilayer ceramic capacitor according to Example 1.

FIG. 9 is a SEM analysis image of an external electrode of a multilayer ceramic capacitor according to Comparative Example 1.

FIG. 10 is a graph showing changes in capacitance versus contents of composite particles of Examples 1 and 5 to 8 and Comparative Example 1.

### DETAILED DESCRIPTION OF THE EMBODIMENTS

In the following detailed description, only certain exemplary embodiments of the present invention have been shown and described, simply by way of illustration. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand exemplary embodiments disclosed in the present specification, and the technical spirit disclosed in the present specification is not limited by the accompanying drawings, and it will be appreciated that the present invention includes all of the modifications, equivalent matters, and substitutes included in the spirit and the technical scope of the present invention.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Further, in the entire specification, when it is referred to as “on a plane”, it means when a target part is viewed from above, and when it is referred to as “on a cross-section”, it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

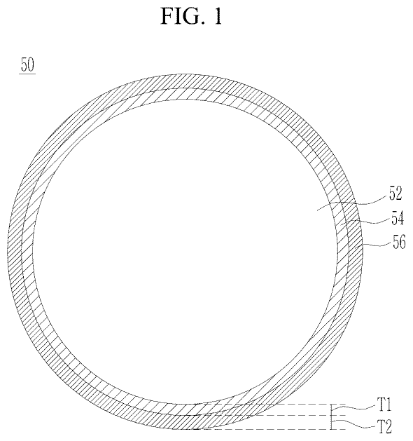

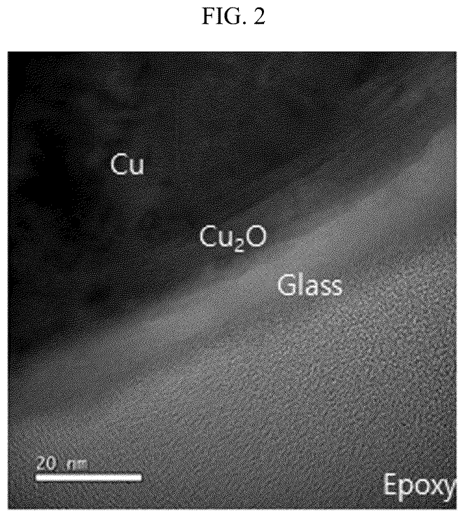

FIG. 1 is a cross-sectional view conceptually showing a composite particle according to an embodiment. FIG. 1 may show a cross-section cut through a center point of a composite particle 50. FIG. 2 is a transmission electron microscopy (TEM) analysis image of a composite particle according to an embodiment. FIG. 2 is an image including a surface portion of the cross-section of the composite particle 50.

The composite particle 50 of the present disclosure can be interpreted as a single particle unit, and can be distinguished from a composite structure in which conductive particles, glass frit, or the like, each of which is a single particle, are arranged adjacent to each other. Glass frit may refer to a glass piece, particle or powder.

Referring to FIGS. 1 and 2, the composite particle 50 according to an embodiment may include a conductive core 52, a conductive oxide layer 54 disposed on the conductive core 52, and a coating 56 disposed on the conductive oxide layer 54. For example, the conductive oxide layer 54 may be disposed on at least a portion of the conductive core 52. The coating 56 may be disposed on at least a portion of the conductive oxide layer 54.

The conductive core 52 may include copper (Cu), nickel (Ni), silver (Ag), palladium (Pd), gold (Au), platinum (Pt), tin (Sn), tungsten (W), titanium (Ti), lead (Pb), an alloy thereof, or the like. These may be used alone or in combination of two or more.

The conductive core 52 may have a spherical or flake shape.

The conductive core 52 may include copper. Accordingly, the electrical conductivity of the composite particle 50 can be improved and structural damage during a process can be suppressed.

In an embodiment, the conductive oxide layer 54 may include a metal oxide. Accordingly, the adhesion between the conductive core 52 and the coating 56 can be improved. Therefore, the structural stability of the composite particle 50 can be enhanced during dispersion, pressurization and/or heating processes.

The metal oxide may include an oxide of metal included in the conductive core 52. For example, the conductive oxide layer 54 may be formed by oxidation of the metal of the conductive core 52.

According to an embodiment, the metal oxide may include copper oxide. Accordingly, when the conductive core 52 contains copper, the adhesion stability between the conductive core 52 and the coating 56 can be further enhanced.

For example, the copper oxide may include Cu₂O.

The conductive oxide layer 54 may be disposed directly on the conductive core 52. Accordingly, the chemical and structural stability of the conductive core 52 can be further enhanced and the adhesion to the coating 56 can be further improved.

According to an embodiment, a thickness T1 of the conductive oxide layer 54 may be in a range from 1 nm to 20 nm. According to another embodiment, the thickness T1 of the conductive oxide layer 54 may be in a range from 3 nm to 10 nm. Within the above ranges, the stability of the composite particle 50 can be sufficiently enhanced, while an increase in size of the composite particle 50 can be suppressed. Therefore, the dispersibility and stability of the composite particle 50 can be further improved.

The composite particle 50 may be present in plurality. When the composite particle 50 conceptually shown in FIG. 1 is present in plurality, the thickness T1 of the conductive oxide layer 54 may be an average value of thicknesses of the conductive oxide layers 54 of the respective composite particles 50.

The thickness T1 may be measured by TEM analysis. After the composite particles 50 are added to an epoxy mixed solution and heat-cured, TEM sampling may be performed using a FIB (Focused Ion Beam). By observing each of the TEM-sampled composite particles 50 using TEM, the thickness of the conductive oxide layer 54 of each composite particle 50 can be measured. The measured thicknesses can be averaged and evaluated as the thickness T1 described above.

According to an embodiment, the coating 56 may include glass.

The glass may contain oxide. Accordingly, the glass can be provided as corrosion resistant glass.

For example, the oxide may include at least one selected from the group consisting of FeO, Fe₂O₃, Fe₃O₄, SnO, SnO₂, CuO, Cu₂O, MnO, Mn₂O, Mn₂O₃, Mn₃O₄, Ag₂O, GeO₂, In₂O₃, CoO, TiO₂, and P₂O₅.

The metal of the conductive core 52 and the oxygen atoms of the oxide may react to form a metal oxide included in the conductive oxide layer.

The metal oxide may be formed between the conductive core 52 and the coating 56 according to the following reaction scheme.

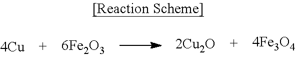

According to an embodiment, a content of the oxide in a total weight of the coating 56 may be 0.01 wt % to 20 wt %. In another embodiment, the content of the oxide in the total weight of the coating 56 may be 1 wt % to 10 wt %. Within the above ranges, the conductive oxide layer 54 is sufficiently formed, further enhancing the structural stability of the composite particle 50 and further suppressing delamination of the coating 56 and/or glass.

The coating 56 may be disposed directly on the conductive oxide layer 54. Accordingly, the bonding strength between the conductive core 52 and the coating 56 can be further improved through the conductive oxide layer 54.

According to an embodiment, a thickness T2 of the coating 56 may be in a range from 1 nm to 50 nm. According to another embodiment, the thickness T2 of the coating 56 may be in a range from 5 nm to 30 nm. Within the above ranges, the size of the glass included in the composite particle 50 is relatively smaller than the glass frit, so that even when the glass is melted, the dispersibility of the glass can be further improved. Additionally, the density of a device including the composite particles 50 can be further enhanced.

The composite particle 50 may be present in plurality. When the composite particle 50 conceptually shown in FIG. 1 is present in plurality, the thickness T2 of the coating 56 may be an average value of thicknesses of the coatings 56 of the respective composite particles 50.

The thickness T2 of the coating 56 may be measured through TEM analysis. After the composite particles 50 are added to an epoxy mixed solution and heat-cured, TEM sampling may be performed using a FIB (Focused Ion Beam). By observing each of the TEM-sampled composite particles 50 using TEM, the thickness of the coating 56 of each composite particle 50 can be measured. The measured thicknesses can be averaged and evaluated as the thickness T2 described above.

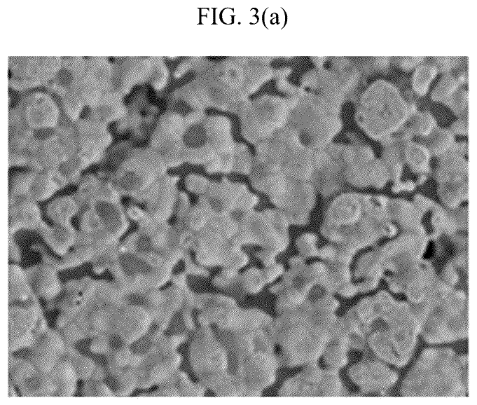

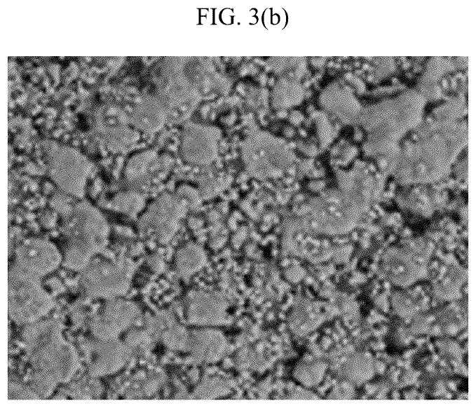

FIGS. 3(a) and 3(b) are scanning electron microscopy (SEM) analysis images showing electrode densities according to coating thicknesses of composite particles in an electrode using composite particles according to an embodiment.

FIGS. 3(a) and 3(b) show SEM analysis images of a cross-section (W-T cross-section) taken along the width direction (W-axis direction) and the stacking direction (T-axis direction) perpendicular to the length direction at a center in the length direction (L-axis direction) of an electrode prepared using the composite particles 50.

FIG. 3(a) is an SEM analysis image when the thickness T2 of the coating 56 is less than 50 nm, and FIG. 3(b) is an SEM analysis image when the thickness T2 of the coating 56 exceeds 50 nm.

Referring to FIGS. 3(a) and 3(b), the density of the electrode is relatively lower when the thickness T2 of the coating 56 exceeds 50 nm compared to when it is less than 50 nm.

According to an embodiment, the thickness of the coating 56 may be uniform throughout the surface portion of the composite particle 50. For example, the thickness of the coating 56 at two points facing each other with respect to the center of the composite particle 50 may be substantially symmetrical. The terms “uniform” or “symmetrical” do not refer only to mathematically exact uniformity or symmetry, but also encompass “substantially uniform or symmetrical.”

Accordingly, the agglomeration of glass can be further suppressed and the dispersibility of the composite particles 50 can be further improved.

According to an embodiment, an average particle diameter (D50) of the composite particles 50 may be in a range from 0.1 μm to 1 μm. According to another embodiment, the average particle diameter (D50) of the composite particles 50 may be in a range from 0.2 μm to 0.8 μm. Within the above ranges, when the composite particles 50 are provided as fine particles in a composition or structure including the composite particles 50, the dispersibility can be further improved and the density can be enhanced.

The term “average particle diameter”, “D50” or “average particle diameter (D50)” as used herein may refer to a size (particle diameter) at the point where the cumulative percentage in the size cumulative distribution becomes 50%. For example, the size cumulative distribution may be obtained by measuring the longest axis of at least 100 composite particles 50 in a SEM analysis image.

Below, a method for manufacturing the composite particle 50 according to another embodiment will be described. For example, the composite particles 50 may be manufactured through a spray pyrolysis method.

In an embodiment, a core precursor and a glass precursor may be introduced into a solvent and mixed to prepare a solution.

The core precursor may include the above-described metal that may be included in the conductive core 52. For example, the glass precursor may include glass and the above-described oxide that may be included in the glass.

The core precursor and/or glass precursor may include a nitrate-based precursor, an acetate-based precursor, or the like.

According to an embodiment, the solution may be sprayed into microdroplets and introduced into a heating furnace.

In an embodiment, composite particles 50 may be formed by drying, melting, and recrystallizing particles formed through the heating. For example, during the heating, drying, melting and recrystallization, the metal included in the core precursor may form a conductive core 52 due to its relatively strong interatomic bonding force, and the glass precursor with relatively weak interatomic bonding force may form a coating 56 on the surface portion of the conductive core 52. For example, a metal oxide (e.g., Fe₂O₃) included in the glass precursor may cause oxidation of metal (e.g., Cu) in the core precursor, thereby forming a conductive oxide layer 54 between the conductive core 52 and the coating 56 including glass. Accordingly, the structural stability of the composite particle 50 can be improved and delamination of the coating 56 can be suppressed.

By using the spray pyrolysis method described above, composite particles 50 having uniform thicknesses of the coating 56 and the conductive oxide layer 54 and a relatively small average particle diameter (D50) can be manufactured.

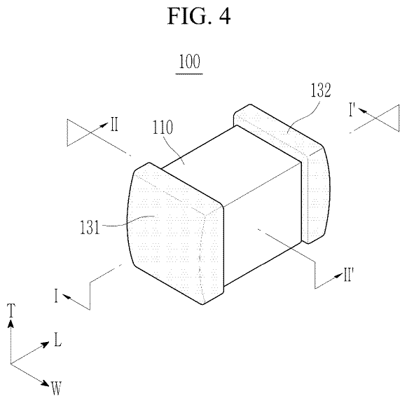

Below, a multilayer ceramic capacitor according to another embodiment will be described with reference to FIGS. 4 to 6.

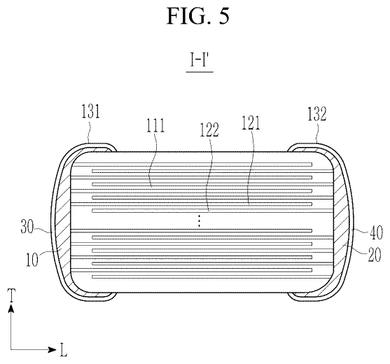

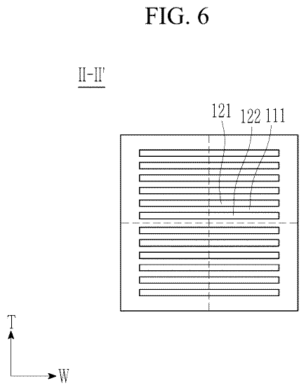

FIG. 4 is a perspective view showing a multilayer ceramic capacitor according to another embodiment. FIG. 5 is a cross-sectional view of the multilayer ceramic capacitor taken along line I-I′ of FIG. 4. FIG. 6 is a cross-sectional view of the multilayer ceramic capacitor taken along line II-II′ of FIG. 4.

Referring to FIGS. 4 to 6, a multilayer ceramic capacitor 100 may include a capacitor body 110 and external electrodes 131 and 132 arranged on an outer side of the capacitor body 110. The external electrodes 131 and 132 may include a first external electrode 131 and a second external electrode 132 arranged at both ends facing each other in the length direction (L-axis direction) of the capacitor body 110.

The L-axis, W-axis, and T-axis shown in FIGS. 4 to 6 represent the length direction, width direction, and thickness direction of the capacitor body 110, respectively. Here, the thickness direction (T-axis direction) may be a direction perpendicular to a wide surface (main surface) of sheet-shaped components, and may be used as the same concept as the stacking direction in which dielectric layers 111 are stacked, for example. The length direction (L-axis direction) may be a direction extending parallel to the wide surface (main surface) of the sheet-shaped components, may be approximately perpendicular to the thickness direction (T-axis direction), and may be, for example, a direction in which the first external electrode 131 and the second external electrode 132 are disposed on both sides. The width direction (W-axis direction) may be a direction extending parallel to the wide surface (main surface) of the sheet-shaped components and may be approximately perpendicular to both the thickness direction (T-axis direction) and the length direction (L-axis direction), and a length in the length direction (L-axis direction) of the sheet-shaped components may be greater than a length in the width direction (W-axis direction).

For example, the capacitor body 110 may have a substantially hexahedral shape.

Below, for convenience of description, both surfaces facing each other in the thickness direction (T-axis direction) of the capacitor body 110 are defined as a first surface and the second surface, both surfaces connected to the first surface and the second surface and facing each other in the length direction (L-axis direction) are defined as a third surface and a fourth surface, and both surfaces connected to the first surface and the second surface, connected to the third surface and the fourth surface, and facing each other in the width direction (W-axis direction) are defined as a fifth surface and a sixth surface.

The first surface, which is a lower surface of the capacitor body 110, may be a surface facing toward a mounting direction of the multilayer ceramic capacitor 100. For example, at least one of the first to sixth surfaces may be flat. For example, at least one of the first to sixth surfaces may be a surface with a convex central portion, and corners, which are boundaries of the respective surfaces, may be rounded.

The shape and dimensions of the capacitor body 110, and the number of dielectric layers 111 stacked are not limited to those shown in the drawings of the present embodiment.

The capacitor body 110 includes a dielectric layer 111 and internal electrode layers 121 and 122. The capacitor body 110 may include a plurality of dielectric layers 111.

The capacitor body 110 includes a plurality of dielectric layers 111, and first internal electrodes 121 and second internal electrodes 122 that are alternately arranged in the thickness direction (T-axis direction) with the dielectric layers 111 interposed therebetween.

The boundaries between adjacent dielectric layers 111 may be integrated to the extent that they are difficult to identify without using an SEM.

The capacitor body 110 may include an active region. The active region may be a portion that contributes to capacitance formation of the multilayer ceramic capacitor 100. For example, the active region may be a region where the first internal electrode 121 or the second internal electrode 122 stacked along the thickness direction (T-axis direction) overlaps.

The capacitor body 110 may further include a cover region and a side margin region.

The cover region is a margin portion in the thickness direction and may be disposed adjacent to the first surface and the second surface of the active region in the thickness direction (T-axis direction), respectively. For example, a single dielectric layer 111 or two or more dielectric layers 111 may be stacked on upper and lower surfaces of the active region, respectively, and provided as the cover region.

The side margin region is a margin portion in the width direction and may be disposed adjacent to the fifth surface and the sixth surface of the active region in the width direction (W-axis direction), respectively. The side margin region may be formed by stacking dielectric green sheets where a conductive paste layer is applied to only a portion of the surface of the dielectric green sheet and the conductive paste layer is not applied to both side sides of the surface of the dielectric green sheet, and then firing the sheets.

The cover region and the side margin region can prevent damage to the first internal electrode 121 and the second internal electrode 122 from physical or chemical stress.

The dielectric layer 111 may include a barium titanate-based compound as a main component. For example, by using the barium titanate-based compound as a dielectric matrix, the dielectric properties of the multilayer ceramic capacitor 100 can be ensured.

The barium titanate-based compound may include BaTiO₃, BaZrO₃, BaSnO₃, CaTiO₃, CaZrO₃, CaSnO₃, SrTiO₃, SrZrO₃, SrSnO₃, or the like. These may be used alone or in combination of two or more.

The dielectric layer 111 may further include a minor component.

The minor component may include manganese (Mn), chromium (Cr), silicon (Si), aluminum (Al), magnesium (Mg), tin (Sn), antimony (Sb), germanium (Ge), gallium (Ga), indium (In), barium (Ba), lanthanum (La), yttrium (Y), actinium (Ac), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), vanadium (V), or the like. These may be used alone or in combination of two or more.

According to an embodiment, an average thickness (average length in the T-axis direction) of the dielectric layer 111 may be in a range from 1.0 μm to 8.0 μm. According to another embodiment, the average thickness (average length in the T-axis direction) of the dielectric layer 111 may be in a range from 2 μm to 6 μm. Within the above ranges, the reliability of the multilayer ceramic capacitor 100 can be further enhanced.

For example, the average thickness of the dielectric layer 111 may be obtained as an arithmetic mean of the thickness of the dielectric layer 111 measured at 10 points spaced apart at a predetermined interval from a central point as a reference point in the length direction (L-axis direction) or width direction (W-axis direction) of the dielectric layer 111 in the SEM analysis image of the cross-sectional sample measured as described above. A spacing between the 10 points may be adjusted according to the scale of the scanning electron microscopy (SEM) image, and may be, for example, in a range from 1 μm to 100 μm, 1 μm to 50 μm, or 1 μm to 10 μm. In this case, all 10 points must be within the dielectric layer 111, and if all 10 points are not within the dielectric layer 111, the position of the reference point may be changed or the spacing between the 10 points may be adjusted.

The first internal electrode 121 and the second internal electrode 122 of the internal electrode layers 121 and 122 may have different polarities. For example, the first internal electrode 121 and the second internal electrode 122 may be alternately arranged to face each other along the T-axis direction with the dielectric layer 111 therebetween. For example, one end of the first internal electrode 121 may be exposed through the third surface of the capacitor body 110, and one end of the second internal electrode 122 may be exposed through the fourth surface of the capacitor body 110.

The first internal electrode 121 and the second internal electrode 122 can be electrically insulated by the dielectric layer 111 arranged therebetween.

An end portion of the first internal electrode 121 exposed through the third surface of the capacitor body 110 may be electrically connected by being joined to the first external electrode 131. For example, an end portion of the second internal electrode 122 exposed through the fourth surface of the capacitor body 110 may be electrically connected by being joined to the second external electrode 132.

The first internal electrode 121 and the second internal electrode 122 may each include conductive metal. For example, the conductive metal may include metal such as Ni, Cu, Ag, Pd or Au, or an alloy thereof (e.g., an Ag—Pd alloy).

The first internal electrode 121 and the second internal electrode 122 may include dielectric particles having the same composition as the ceramic material included in the dielectric layer 111.

The first internal electrode 121 and the second internal electrode 122 may be formed using a conductive paste including a conductive metal. For example, the conductive paste can be printed via a screen printing method or a gravure printing method. According to an embodiment, an average thickness of the first internal electrode 121 and the second internal electrode 122 may be in a range from 0.1 μm to 2 μm. Within the above range, as the miniaturization and thinning of the multilayer ceramic capacitor 100 are implemented, the resistance can be further reduced.

The average thickness of the first internal electrode 121 and the second internal electrode 122 may be measured by SEM analysis. The SEM analysis may be substantially the same as the above-described method for measuring the average thickness of the dielectric layer 111.

The capacitor body 110 may be formed by firing a laminate in which a plurality of dielectric layers 111 and internal electrode layers 121 and 122 are stacked.

Referring to FIG. 5, the first external electrode 131 and the second external electrode 132 may have different polarities.

The first external electrode 131 may be electrically connected to the exposed portion of the first internal electrode 121. For example, the second external electrode 132 may be electrically connected to the exposed portion of the second internal electrode 122.

When a predetermined voltage is applied to the first external electrode 131 and the second external electrode 132, charges can be accumulated between the first internal electrode 121 and the second internal electrode 122 facing each other. The electrostatic capacitance of the multilayer ceramic capacitor 100 may be proportional to the overlapping area on the plane of the first internal electrode 121 and the second internal electrode 122 that overlap each other in the stacking direction (T-axis direction) in the active region.

The first external electrode 131 and the second external electrode 132 may include first and second connecting portions (not shown) respectively arranged on the third surface and the fourth surface of the capacitor body 110 and respectively connected to the first internal electrode 121 and the second internal electrode 122. The first external electrode 131 and the second external electrode 132 may include first and second band portions (not shown) arranged at corners, where the third and fourth surfaces, the first and second surfaces, or the fifth and sixth surfaces of the capacitor body 110 meet, respectively.

The first and second band portions may extend from the first and second connection portions to portions of the first and second surfaces or the fifth and sixth surfaces of the capacitor body 110, respectively. The adhesion strength of the first external electrode 131 and the second external electrode 132 can be improved through the first and second band portions.

The external electrodes 131 and 132 may include electrode layers 10 and 20 disposed directly on the surfaces of the capacitor body 110.

The first external electrode 131 may include a first electrode layer 10 disposed directly on a surface (e.g., the third surface) of the capacitor body 110 and electrically connected to the first internal electrode 121. For example, the second external electrode 132 may include a second electrode layer 20 disposed directly on a surface (e.g., the fourth electrode) of the capacitor body 110 and electrically connected to the second internal electrode 122.

The electrode layers 10 and 20 may include the composite particles 50 described above. As described above, the composite particle 50 may include the conductive core 52, the conductive oxide layer 54 disposed on the conductive core 52 and including a metal oxide, and the coating 56 disposed on the conductive oxide layer 54 and including glass. The dispersibility of the electrode layers 10 and 20 is enhanced through the composite particles 50, so that the contact between the external electrodes 131 and 132 and the internal electrodes 121 and 122 is enhanced and the capacitance characteristics can be improved.

The electrode layers 10 and 20 may be formed by applying an electrode paste onto the capacitor body 110 and sintering the same.

According to an embodiment, instead of using conductive particles (e.g., copper particles) and glass frits individually as a composition of the electrode paste, the composite particles 50 in which an oxide layer and glass are coated on a conductive core may be used. Accordingly, the decrease in electrode density due to melting of coarse glass frits can be suppressed, and the decrease in glass dispersibility due to over-agglomeration of fine glass frits can be prevented. Therefore, the structural stability of the external electrodes 131 and 132 can be improved and the capacitance characteristics of the multilayer ceramic capacitor 100 can be enhanced.

The electrode layers 10 and 20 may include multiple glasses.

According to an embodiment, an average area of the glasses included in the electrode layers 10 and 20 may be in a range from 0.1 μm² to 5 μm². Within the above range, the coarse glass frits are reduced, so that the density of the electrode after sintering is further enhanced. Additionally, the glasses are sufficiently dispersed, so that a decrease in output or capacitance of the multilayer ceramic capacitor 100 can be suppressed.

The average area of the glasses may be measured by performing SEM analysis on a cross-section (L-T cross-section) taken along the length direction (L-axis direction) and the stacking direction (T-axis direction) perpendicular to the width direction at the center in the width direction (W-axis direction) of the multilayer ceramic capacitor 100.

The average area of the glasses may be an average of respective areas of the multiple glasses observed in the cross-section.

To measure the average area of the glasses, the multilayer ceramic capacitor 100 may be fixed with epoxy resin and polished with a polisher so that the cross-section is exposed. The polishing may be performed to remove half of a length in the width direction (W-axis direction). For the exposed cross-section, a rectangular region measuring 300 μm in width and 30 μm in length may be set at the central portion of the electrode layers 10 and 20, and the rectangular region may be divided into six sub-rectangular regions each having a size of 40 μm in width and 30 μm in length. For each of the sub-rectangular regions, scanning electron microscopy (SEM) analysis images may be obtained, and the cross-sectional area of each individual glass may be measured using an image analysis program (e.g., ImageJ software). The average area may be obtained by averaging the cross-sectional areas of all glasses included in the six sub-rectangular regions.

The electrode layers 10 and 20 may further include at least one selected from the group consisting of a conductive particle, a glass frit, and an organic material.

The conductive particle may include the same type of material as the above-described conductive core 52. The glass frit may include the same type of material as the glass included in the above-described coating 56.

The organic material may include a binder, a dispersant, a plasticizer, and the like. These may be used alone or in combination of two or more. The material that can be used as the organic material may not be limited as long as it is a material that can be selected in the art as needed.

As described above, the composite particle 50 including the conductive core 52, the conductive oxide layer 54 and the glass-containing coating 56 may replace at least a portion of the conductive particle and the glass frit. Accordingly, the density of the external electrodes 131 and 132 can be improved and the glass dispersibility can be enhanced.

According to an embodiment, a content of the composite particles 50 in a total weight of the composite particles 50 and the conductive particles included in the electrode layers 10 and 20 may be in a range from 40 wt % to 100 wt %, and according to another embodiment, may be in a range from 60 wt % to 100 wt %. Within the above ranges, the glasses in the electrode layers 10 and 20 can be sufficiently dispersed and the density can be further improved. Accordingly, the capacitance characteristics of the multilayer ceramic capacitor 100 can be further enhanced.

According to an embodiment, the external electrode 131 and 132 may further include plating layers 30 and 40 disposed on the electrode layers 10 and 20.

The external electrodes 131 and 132 may optionally further include a conductive resin layer (not shown) disposed between the electrode layers 10 and 20 and the plating layers 30 and 40.

The conductive resin layers may extend to the first surface and the second surface or the fifth surface and the sixth surface of the capacitor body 110. In this case, a length of a region (e.g., band portion) where the conductive resin layers are arranged may be greater than a length of a region (e.g., band portion) where the electrode layers 10 and 20 are arranged to extend to the first and second surfaces or the fifth and sixth surfaces of the capacitor body 110. For example, the conductive resin layers may entirely cover the electrode layers 10 and 20.

The conductive resin layer may include a resin and a conductive metal.

The resin is not particularly limited as long as it has adhesion and shock absorption properties and can be mixed with conductive metal powder to make a paste, and may include, for example, phenol resin, acrylic resin, silicone resin, epoxy resin, or polyimide resin.

The conductive metal may be electrically connected to the internal electrode layer 121 and 122 or the electrode layers 10 and 20.

The conductive metal may have a spherical shape, a flake shape, or a combination thereof. For example, the conductive metal may have only a flake shape or only a spherical shape, or may be in a mixed form of flake and spherical shapes.

The spherical shape may also include a shape that is not a perfect sphere, for example, a shape having a length ratio of a major axis to a minor axis (major axis/minor axis) of 1.45 or less. Flake-shaped powder refers to a powder having a flat and elongated shape, and is not particularly limited, but for example, the length ratio of the major axis to the minor axis (major axis/minor axis) may be 1.95 or greater.

The external electrode 131 and 132 may further include plating layer 30 and 40 arranged to cover the conductive resin layers described above.

The plating layers 30 and 40 may include a first plating layer 30 arranged on the first electrode layer 10 and a second plating layer 40 arranged on the second electrode layer 20.

The plating layers 30 and 40 may include nickel (Ni), copper (Cu), tin (Sn), palladium (Pd), platinum (Pt), gold (Au), silver (Ag), tungsten (W), titanium (Ti), lead (Pb), an alloy thereof, or the like. These may be used alone or in combination of two or more.

The plating layers 30 and 40 may each be a nickel (Ni) plating layer or a tin (Sn) plating layer. For example, the plating layers 30 and 40 may each include a form in which a nickel (Ni) plating layer and a tin (Sn) plating layer are sequentially stacked, or a form in which a tin (Sn) plating layer, a nickel (Ni) plating layer, and a tin (Sn) plating layer are sequentially stacked. For example, the plating layers 30 and 40 may each include a plurality of nickel (Ni) plating layers and/or a plurality of tin (Sn) plating layers.

Through the plating layers 30 and 40, mountability on a substrate, structural reliability, durability against external impact, heat resistance, and equivalent series resistance (ESR) of the multilayer ceramic capacitor 100 can be improved.

Below, a method for manufacturing a multilayer ceramic capacitor 100 according to another embodiment will be described.

A method for manufacturing a multilayer ceramic capacitor 100 may include steps of manufacturing a capacitor body 110 including a dielectric layer 111 and internal electrodes 121 and 122, and forming external electrodes 131 and 132 on an outer side of the capacitor body 110.

In the manufacturing process of the capacitor body 110, a dielectric paste that becomes the dielectric layer 111 after firing and a conductive paste that becomes the internal electrodes 121 and 122 after firing may be prepared.

A dielectric powder may be uniformly mixed through wet mixing or the like, dried, and then heat-treated under predetermined conditions to obtain a calcined powder. An organic vehicle or an aqueous vehicle may be added to the calcined powder, which may be then heated and mixed to prepare the dielectric paste.

The dielectric paste may be formed into a sheet using a technique such as a doctor blade method to obtain a dielectric green sheet. For example, the dielectric paste may include additives selected from various dispersants, plasticizers, dielectrics, minor component compounds, and/or glass.

The conductive paste for an internal electrode may be prepared by kneading conductive powder made of a conductive metal or an alloy thereof with a binder or solvent.

The conductive paste for an internal electrode may contain indium (In).

The conductive paste for an internal electrode may include ceramic powder (e.g., barium titanate powder) as a co-material. The co-material can suppress sintering of the conductive powder during the sintering process.

The conductive paste for an internal electrode may be applied in a predetermined pattern to the surface of the dielectric green sheet by using various printing methods such as screen printing or a transfer method. Then, multiple layers of dielectric green sheets having internal electrode patterns formed thereon may be stacked and then pressed in a stacking direction to obtain a dielectric green sheet laminate. The dielectric green sheets and the internal electrode patterns may be stacked such that the dielectric green sheets are disposed on the upper and lower surfaces of the dielectric green sheet laminate in the stacking direction.

Optionally, the dielectric green sheet laminate may be cut into a predetermined size by dicing or the like.

The dielectric green sheet laminate may be solidified and dried to remove plasticizers and the like, as needed, and may be subjected to barrel polishing using a horizontal centrifugal barrel machine or the like after solidified and dried. In the barrel polishing, the dielectric green sheet laminate may be put into a barrel container together with a medium and a polishing liquid, and the barrel container may be applied with rotational motion or vibration, resulting in polishing of unnecessary parts such as burrs generated during cutting. For example, after barrel polishing, the dielectric green sheet laminate may be washed with a cleaning solution such as water and dried.

The dielectric green sheet laminate may be subjected to binder removing and firing treatments to obtain a capacitor body 110.

The conditions for the binder removing treatment may be appropriately adjusted depending on the main component composition of the dielectric layer or the main component composition of the internal electrode. For example, a temperature increase rate during the binder removing treatment may be in a range from 5° C./hour to 300° C./hour, a support temperature may be in a range from 180° C. to 400° C., and a temperature holding time may be in a range from 0.5 hour to 24 hours. The binder removing atmosphere may be air or a reducing atmosphere.

The conditions for the sintering treatment may be appropriately adjusted depending on the main component composition of the dielectric layer or the main component composition of the internal electrode. For example, the temperature during firing may be in a range from 1200° C. to 1350° C., or 1220° C. to 1300° C., and the time may be in a range from 0.5 hour to 8 hours, or 1 hour to 3 hours. The firing atmosphere may be a reducing atmosphere, for example, a humidified atmosphere of a mixed gas of nitrogen gas (N₂) and hydrogen gas (H₂). When the internal electrode 121 and 122 include nickel (Ni) or a nickel (Ni) alloy, an oxygen partial pressure in the firing atmosphere may be in a range from 1.0×10⁻¹⁴ MPa to 1.0×10⁻¹⁰ MPa.

After the firing treatment, annealing may be performed as needed. The annealing is a treatment for re-oxidizing the dielectric layer, and annealing may be performed when the firing treatment is performed in a reducing atmosphere. The conditions for annealing treatment may also be appropriately adjusted depending on the main component composition of the dielectric layer and the like. For example, the temperature during annealing may be in a range from 950° C. to 1150° C., the time may be in a range from 0 hour to 20 hours, and the temperature increase rate may be in a range from 50° C./hour to 500° C./hour. The annealing atmosphere may be a humidified nitrogen gas (N₂) atmosphere, and the oxygen partial pressure may be in a range from 1.0×10⁻⁹ MPa to 1.0×10⁻⁵ MPa.

In the binder removing treatment, the firing treatment, or the annealing treatment, for example, a wetter may be used to humidify a nitrogen gas, a mixed gas, or the like, and in this case, the water temperature may be in a range from 5° C. to 75° C. The binder removing treatment, the firing treatment, and the annealing treatment may be performed consecutively or independently.

Optionally, a surface treatment such as sandblasting, laser irradiation, or barrel polishing may be performed on the third and fourth surfaces of the obtained capacitor body 110. Through such a surface treatment, the end portions of the first internal electrode 121 and the second internal electrode 122 can be exposed on the outermost surfaces of the third and fourth surfaces. Accordingly, the electrical connection between the first external electrode 131 and the second external electrode 132 and the first internal electrode 121 and the second internal electrode 122 is improved, and an alloy portion can be easily formed.

A paste for forming an electrode layer may be applied to an outer surface of the capacitor body 110 and then sintered to form electrode layers 10 and 20, resulting in preparation of external electrodes 131 and 132.

The paste for forming an electrode layer may include the above-described composite particles 50 and optionally a conductive metal. Accordingly, the glass dispersibility in the electrode layers 10 and 20 is enhanced, so that the contact between the internal electrodes 121 and 122 and the external electrodes 131 and 132 is improved and the capacitance characteristics of the multilayer ceramic capacitor 100 can be enhanced.

According to an embodiment, a content of the composite particles 50 may be in a range from 40 wt % to 100 wt % of a total weight of the composite particles 50 and the conductive metal, and in another embodiment, may be in a range from 60 wt % to 100 wt %. Within the above ranges, the glasses within the electrode layers 10 and 20 after sintering can be sufficiently dispersed and the density can be further improved. Accordingly, the capacitance characteristics of the multilayer ceramic capacitor 100 can be further enhanced.

The paste for forming an electrode layer may further include a binder, a solvent, a dispersant, a plasticizer, an oxide powder, or the like.

For the binder, for example, ethyl cellulose, acrylic, butyral, or the like may be used, and for the solvent, for example, an organic solvent such as terpineol, butyl carbitol, alcohol, methyl ethyl ketone, acetone, or toluene, or an aqueous solvent may be used.

A method for applying the paste for forming an electrode layer to the outer surface of the capacitor body 110 may include a dip method, various printing methods such as a screen printing, an applying method using, for example, a dispenser, or a spraying method using a spray. The paste for forming an electrode layer is applied to at least the third surface and the fourth surface of the capacitor body 110, and optionally may also be applied to a portion of the first surface, the second surface, the fifth surface, or the sixth surface where the band portions of the first external electrode and the second external electrode are formed.

The sintering may be performed at a temperature in a range from 400° C. to 860° C. When sintering is performed within the above temperature range, nickel oxide (NiO) can be easily reduced to form a Cu—Ni alloy. The formation of the Cu—Ni alloy can enhance the connectivity between the external electrode and the internal electrode layer, improve the capacitance distribution, and reduce the ESR.

Next, optionally, a paste for forming a conductive resin layer may be applied to the outer surface of the capacitor body 110 on which the electrode layers 10 and 20 have been formed, and then cured to form a conductive resin layer.

The paste for forming a conductive resin layer may include a resin, and optionally a conductive metal or a non-conductive filler. The description of the conductive metal and resin is the same as the above description, so a redundant description will be omitted. Additionally, the paste for forming a conductive resin layer may optionally include a binder, a solvent, a dispersant, a plasticizer, an oxide powder, or the like. For the binder, for example, ethyl cellulose, acrylic, butyral, or the like may be used, and for the solvent, for example, an organic solvent such as terpineol, butyl carbitol, alcohol, methyl ethyl ketone, acetone, or toluene, or an aqueous solvent may be used.

For example, a method for forming a conductive resin layer may include dipping the capacitor body 110 in a paste for forming a conductive resin layer and then curing it, printing a paste for forming a conductive resin layer on a surface of the capacitor body 110 using a screen printing method, a gravure printing method, or the like, or applying a paste for forming a conductive resin layer on a surface of the capacitor body 110 and then curing it.

Plating layers 30 and 40 may be formed on the outer side of the conductive resin layer.

The plating layers 30 and 40 may be formed by a plating method, a sputtering method, or an electric deposition method.

Below, specific examples of the invention are presented. However, the examples described below are only for illustrating or describing the invention in detail and should not be construed as limiting the scope of the present disclosure.

### Experimental Example 1

### Examples 1 to 4

### (Preparation of Composite Particles)

A solution was prepared by adding and mixing copper nitrate (Cu nitrate) as a copper precursor, and barium nitrate (Ba nitrate), calcium nitrate (Ca nitrate), aluminum nitrate (Al nitrate), zinc nitrate (Zn nitrate), boric acid, and tetraethoxysilane (TEOS) as a glass precursor into 50 mL of distilled water. The weight ratio of the copper precursor and the glass precursor was adjusted to 95:5.

The solution was introduced into an ultrasonic droplet generator and sprayed in the form of fine droplets into a heating furnace maintained at 900° C. In this case, an argon mixed gas (Ar:H₂, volume ratio of 9:1) was introduced as the carrier gas at a flow rate of 5 L/min. The fine droplets were sprayed, dried, melted, and recrystallized, resulting in the preparation of first composite particles having an average particle diameter (D50) of 0.1 μm to 1 μm and a coating that includes glass and has a thickness of 1 nm to 50 nm.

The average particle diameter (D50) and the coating thickness can be measured by the methods described in the detailed description of the invention (e.g., TEM analysis).

The weight ratio of the copper precursor and the glass precursor was changed to 90:10, 85:15, and 80:20, respectively, to prepare second composite particles, third composite particles, and fourth composite particles.

### (Preparation of Multilayer Ceramic Capacitors)

A dielectric green sheet laminate was prepared by preparing a dielectric green sheet using barium titanate (BaTiO₃) as the main component powder, then printing a conductive paste layer containing nickel (Ni) on a surface of the dielectric green sheet, and stacking and pressing the dielectric green sheets (width×length×height=3.2 mm×2.5 mm×2.5 mm) with the conductive paste layer formed thereon. The dielectric green sheet laminate was subjected to a calcination process at 400° C. or below in a nitrogen atmosphere, and then fired under conditions of a firing temperature of 1300° C. or below and a hydrogen (H₂) concentration of 1.0% or less, resulting in preparation of a capacitor body.

A paste for forming an electrode layer was prepared, including 80 wt % of the composite particles, 15 wt % of a binder, 1 wt % of a dispersant, and 4 wt % of a solvent. The paste for forming an electrode layer was applied to an outer surface of the capacitor body and dried, and sintered at about 800° C., resulting in formation of an electrode layer of an external electrode.

The first composite particles described above were used as the composite particles in Example 1. The second composite particles described above were used as the composite particles in Example 2. The third composite particles described above were used as the composite particles in Example 3. The fourth composite particles described above were used as the composite particles in Example 4.

A nickel (Ni) plating layer and a tin (Sn) plating layer were sequentially formed on a surface of the electrode layer, resulting in preparation of a multilayer ceramic capacitor.

### Comparative Example 1

A multilayer ceramic capacitor was prepared in the same manner as in Example 1, except that a paste for forming an electrode layer including 70 wt % of copper (Cu), 10 wt % of glass frits, 15 wt % of a binder, 1 wt % of a dispersant, and 4 wt % of a solvent was used instead of the paste for forming an electrode layer containing composite particles.

### Comparative Examples 2 to 4

Multilayer ceramic capacitor were prepared in the same manner as in Comparative Example 1, except that the content of glass frits in the total weight of the paste for forming an electrode layer was changed to 15 wt % (Comparative Example 2), 20 wt % (Comparative Example 3), and 25 wt % (Comparative Example 4), respectively, and the copper content was reduced by the increased amount of glass frits.

### Evaluation—Measurement of Average Area of Glasses In Electrode Layer

The multilayer ceramic capacitors according to the Examples and Comparative Examples were laid down horizontally, and the peripheries of the multilayer ceramic capacitors were fixed with epoxy resin, respectively.

The multilayer ceramic capacitors were polished using a polisher so that a cross-section taken along the length direction (L-axis direction) and the stacking direction (W-axis direction) perpendicular to the width direction at the center in the width direction (W-axis direction) of the multilayer ceramic capacitor was exposed.

For the exposed cross-section, a rectangular region measuring 300 μm in width (the W-axis direction) and 30 μm in length (the L-axis direction) was set at the central portion of each of the electrode layers 10 and 20, and the rectangular region was divided into six sub-rectangular regions each having a size of 40 μm in width (the W-axis direction) and 30 μm in length (the L-axis direction).

The SEM imaging was performed on each of the sub-rectangular regions to obtain six SEM analysis images.

The areas of individual glasses included in the SEM analysis images were measured using the Analyze Particles function of Image J, an image analysis program.

The average area was obtained by averaging the areas of all glasses included in the six sub-rectangular regions.

Additionally, the diameter can be obtained by assuming the shape of each individual glass to be circular and converting it.

The average diameter was obtained by averaging the converted diameters of all glasses included in the six sub-rectangular areas.

The components of the electrode layer of the external electrode, and the average area and average diameter of the glasses included in the electrode layer are shown in Table 1 below.

TABLE 1

| | | Average | Average |
|---|---|---|---|
| | Components of the | area of | diameter of |
| | electrode layer | glasses (μm²) | glasses (μm) |
| Example 1 | First composite particle | 0.1 | 0.36 |
| Example 2 | Second composite particle | 0.785 | 1 |
| Example 3 | Third composite particle | 2.7 | 1.85 |
| Example 4 | Fourth composite particle | 5 | 2.52 |
| Comparative | Cu + glass frits | 10 | 3.57 |
| Example 1 | | | |
| Comparative | Cu + glass frits | 15 | 4.37 |
| Example 2 | | | |
| Comparative | Cu + glass frits | 20 | 5.05 |
| Example 3 | | | |
| Comparative | Cu + glass frits | 30 | 6.18 |
| Example 4 | | | |

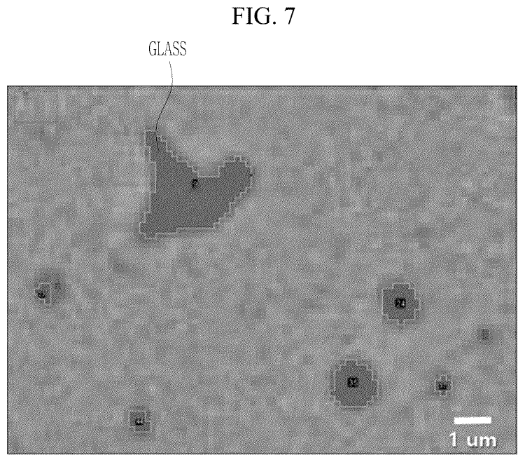

FIG. 7 is a SEM analysis image of the electrode layer of the external electrode of the multilayer ceramic capacitor according to Example 3.

Referring to Table 1 and FIG. 7, in the Examples including the composite particles including a conductive core, a conductive oxide layer, and a glass-containing coating, the average area and diameter of the glasses were relatively smaller compared with the Comparative Examples in which copper particles and glass frits were separately introduced, thereby improving the density of the electrode layer and the dispersibility of the glass.

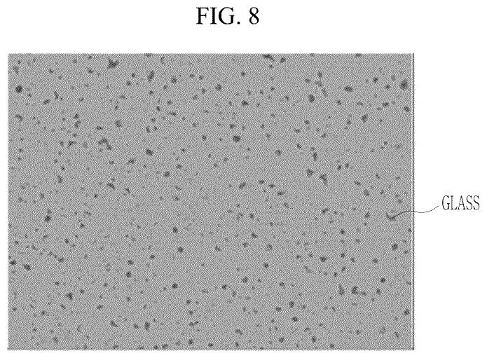

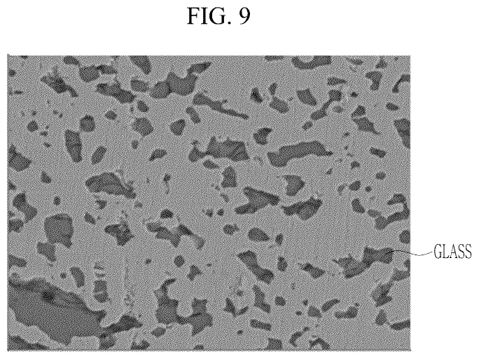

FIGS. 8 and 9 are SEM analysis images of the external electrodes of the multilayer ceramic capacitors according to Example 1 and Comparative Example 1, respectively.

Referring to FIGS. 8 and 9, in Example 1 using the composite particles, the glass size and diameter were reduced and the dispersibility and the density of the electrode layer were improved compared with Comparative Example 1 using the copper particles and the glass frits.

### Experimental Example 2

### Example 5

A multilayer ceramic capacitor was prepared in the same manner as in Example 1, except that a paste for forming an electrode layer including 14 wt % of the first composite particles, 56 wt % of copper (Cu), 10 wt % of glass frits, and organic materials (e.g., 15 wt % of a binder, 1 wt % of a dispersant, and 4 wt % of a solvent) was used.

### Examples 6 to 8

Multilayer ceramic capacitor were prepared in the same manner as in Example 5, except that the content of the first composite particles in the total weight of the paste for forming an electrode layer was changed to 28 wt % (Example 6), 42 wt % (Example 7), and 56 wt % (Example 8), respectively, and the copper content was changed to 42 wt % (Example 6), 28 wt % (Example 7), and 14 wt % (Example 8), respectively.

### Evaluation—Capacitance Measurement

The rated voltage was applied to the multilayer ceramic capacitors of Examples 1 and 5 to 8 and Comparative Example 1 to measure the capacitance.

Specifically, the capacitance was measured under conditions of 1 kHz and 1 V using Agilent 4268A available from HP/Agilent.

The measurement results were evaluated as follows.
∘: The capacitance distribution falls within the range of 1.62 μF to 2.37 μF
Δ: The capacitance distribution overlaps the range of 1.3 μF or higher and less than 1.61 μF
X: The capacitance distribution falls within the range of less than 1.3 μF

The content of the composite particles in the total weight of the composite particles and copper, and the results of capacitance evaluation are shown in Table 2 below.

TABLE 2

| | Composite particle | Capacitance |
|---|---|---|
| | content (wt %) | evaluation |
| Example 1 | 100 | ◯ |
| Example 5 | 20 | Δ |
| Example 6 | 40 | ◯ |
| Example 7 | 60 | ◯ |
| Example 8 | 80 | ◯ |
| Comparative Example 1 | 0 | X |

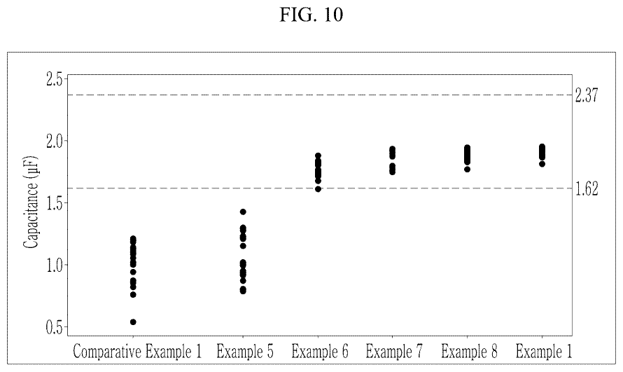

FIG. 10 is a graph showing changes in capacitance versus contents of the composite particles in the total weight of the composite particles and copper of Examples 1 and 5 to 8 and Comparative Example 1. Referring to Table 2 and FIG. 10, in Examples 1 and 6 to 8 where the content of the composite particles in the total weight of the composite particles and copper was 40 wt % to 100 wt %, the composite particles were sufficiently dispersed within the electrode layer, so that the capacitance characteristics of the multilayer ceramic capacitors were relatively enhanced.

In Example 5 where the content of the composite particles in the total weight of the composite particles and copper was less than 40 wt % (20 wt %), the glass dispersibility within the electrode layer was relatively reduced, resulting in a deterioration in the capacitance characteristics of the multilayer ceramic capacitor compared with the other Examples.

In Comparative Example 1 where no composite particles were used, the capacitance characteristics of the multilayer ceramic capacitor were deteriorated compared with the Examples.

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

### DESCRIPTION OF SYMBOLS

10: first electrode layer
20: second electrode layer
30: first plating layer
40: second plating layer
50: composite particle
52: conductive core
54: conductive oxide layer
56: coating
100: multilayer ceramic capacitor
110: capacitor body
111: dielectric layer
121: first internal electrode
122: second internal electrode
131: first external electrode
132: second external electrode

What is claimed is:

1. A composite particle comprising:
a conductive core;
a conductive oxide layer disposed on the conductive core and comprising a metal oxide, and
a coating disposed on the conductive oxide layer and comprising glass.

2. The composite particle of claim 1, wherein:
the conductive core comprises copper.

3. The composite particle of claim 1, wherein:
the metal oxide comprises a copper oxide.

4. The composite particle of claim 1, wherein:
the glass comprises at least one oxide selected from the group consisting of FeO, Fe₂O₃, Fe₃O₄, SnO, SnO₂, CuO, Cu₂O, MnO, Mn₂O, Mn₂O₃, Mn₃O₄, Ag₂O, GeO₂, In₂O₃, CoO, TiO₂, and P₂O₅.

5. The composite particle of claim 4, wherein:
a content of the oxide in a total weight of the coating is in a range from 0.01 wt % to 20 wt %.

6. The composite particle of claim 1, wherein:
a thickness of the conductive oxide layer is in a range from 1 nm to 20 nm.

7. The composite particle of claim 1, wherein:
a thickness of the coating is in a range from 1 nm to 50 nm.

8. The composite particle of claim 1, having an average particle diameter (D50) of in a range from 0.1 μm to 1 μm.

9. A multilayer ceramic capacitor comprising:
a capacitor body comprising a dielectric layer and an internal electrode layer; and
an external electrode disposed on an outer side of the capacitor body and comprising a composite particle,
wherein the composite particle comprises a conductive core, a coating disposed on the conductive core and comprising glass, and a conductive oxide layer disposed between the conductive core and the coating and comprising a metal oxide.

10. The multilayer ceramic capacitor of claim 9, wherein
the internal electrode layer is provided in plurality, and the external electrode comprises an electrode layer disposed on an end surface of the capacitor body so as to be electrically connected to the internal electrode layer, and
the electrode layer comprises the composite particle.

11. The multilayer ceramic capacitor of claim 10, wherein
the internal electrode layer comprises a first internal electrode and a second internal electrode alternately stacked in a stacking direction, the multilayer ceramic capacitor has a width direction and a length direction that are perpendicular to the stacking direction and perpendicular to each other, and
in a cross-section taken along the length direction and the stacking direction perpendicular to the width direction at a center in the width direction of the multilayer ceramic capacitor, an average area of glass included in the electrode layer is in a range from 0.1 μm² to 5 μm².

12. The multilayer ceramic capacitor of claim 11, wherein:
the average area of the glasses is measured by performing scanning electron microscopy (SEM) analysis on the electrode layer in the cross-section.

13. The multilayer ceramic capacitor of claim 10, wherein:
the electrode layer further comprises at least one selected from the group consisting of a conductive particle, a glass frit, and an organic material.

14. The multilayer ceramic capacitor of claim 13, wherein:
a content of the composite particle in a total weight of the composite particle, the conductive particle, and the glass frit is in a range from 40 wt % to 100 wt %.

15. A method for manufacturing a multilayer ceramic capacitor, the method comprising:
applying a paste for forming an electrode layer to one surface of a capacitor body comprising a dielectric layer and an internal electrode layer; and
sintering the paste to form the electrode layer of an external electrode, wherein
the paste comprises a composite particle and optionally a conductive metal, and
a content of the composite particle is in a range from 40 wt % to 100 wt % of a total weight of the composite particle and the conductive metal.

16. The method of claim 15, wherein:
the paste further comprises at least one selected from the group consisting of glass frit and an organic material.
